(19) United States
(12) Patent Application Publication
(10) Pub. No.: US 2025/0334163 A1
(43) Pub. Date: Oct. 30, 2025

(54) VARIABLE PARAMETER FRICTION DAMPER

(71) Applicant: BEIJING UNIVERSITY OF CIVIL ENGINEERING AND ARCHITECTURE, Beijing (CN)

(72) Inventors: Xiangjie LI, Beijing (CN); Cantian YANG, Beijing (CN); Aiqun LI, Beijing (CN); Linlin XIE, Beijing (CN); Hang SUN, Beijing (CN); Yang HE, Beijing (CN)

(73) Assignee: BEIJING UNIVERSITY OF CIVIL ENGINEERING AND ARCHITECTURE, Beijing, HE (CN)

(21) Appl. No.: 18/644,180

(22) Filed: Apr. 24, 2024

(51) Int. Cl. F16F 7/02

(52) U.S. Cl. CPC F16F 7/023

(57) ABSTRACT

The invention pertains to the field of friction dampers, specifically focusing on a variable parameter friction damper. It comprises a rotation energy dissipation unit, comprising a first rotation arm, a second rotation arm, a friction plate, and a pressure regulating component. The first rotation arm has a first rotation part and a second rotation part, while the second rotation arm has a third rotation part and a fourth rotation part. The first and third rotation parts rotate around a first axis, with the friction plate positioned between them. The pressure regulating component adjusts the distance between the first and third rotation parts. The second and fourth rotation parts are hinged on the building matrix. This damper can adaptively adjust bearing capacity and energy dissipation based on external excitation levels and disaster types, showcasing strong adaptability to varying deformation levels.

### TECHNICAL FIELD

The invention relates to the technical field of friction damper, in particular to a variable parameter friction damper.

### BACKGROUND ART

Earthquake is a natural disaster that human society cannot avoid. Most of the personnel casualties and economic losses caused by the earthquake are due to the collapse of buildings. Therefore, passive control technology is proposed in the field of architecture, the passive control technology mainly adopts two methods: energy dissipation-seismic reduction and seismic isolation. Among them, the method of energy dissipation-seismic reduction controls the dynamic response of the building structure under the action of earthquake by introducing some energy dissipation-seismic reduction devices that can dissipate seismic energy, so as to protect the main structure. It is simple and reliable, and it is one of the main means of seismic design in modern society.

Friction damper is a commonly used energy dissipation device, which dissipates energy by friction work, it has the advantages of simple structure, low engineering cost and stable energy dissipation performance. The traditional friction dampers are all single-stage type, which remain elastic before friction start-up. After friction start-up, the bearing capacity is a single and fixed constant value, which can not adaptively provide the required bearing capacity and energy dissipation performance when the structure encounters different levels of external excitation.

### SUMMARY

The purpose of the invention is to provide a variable parameter friction damper to alleviate the technical problem of poor adaptability of the friction damper in the existing technology.

The variable parameter friction damper provided by the invention includes a rotation energy dissipation unit, which includes a first rotation arm, a second rotation arm, a friction plate and a pressure regulating component.

The first rotation arm has a first rotation part and a second rotation part, and the second rotation arm has a third rotation part and a fourth rotation part, the first rotation part and the third rotation part rotate around the first axis, and the friction plate is squeezed between the first rotation part and the third rotation part, the pressure regulating component is used to adjust the distance between the first rotation part and the third rotation part, and the second rotation part and the fourth rotation part are respectively hinged on the building matrix.

Preferably, as an implementable method, the pressure regulating component includes the first synchronous structure and the second synchronous structure, the first synchronous structure is fixed or integrated with the first rotation part, and the second synchronous structure is fixed or integrated with the third rotation part; the first synchronous structure and the second synchronous structure are set relatively along the first axis, the first synchronous structure has the first inclined plane, and the second synchronous structure has the second inclined plane, the first inclined plane and the second inclined plane form an angle with the first axis and are set relatively to each other along the circumferential direction.

Preferably, as an implementable method, the first synchronous structure is provided with a convex part toward the second synchronous structure, the second synchronous structure is provided with a groove, the convex part is matched with the groove, the two first side walls opposite to the convex part have the first inclined plane, and the two second side walls opposite to the groove have the second inclined plane.

Preferably, as an implementable method, there is a gap between the first sidewall and the second sidewall;
and/or, the first side wall has a number of segments of the first inclined plane distributed along the first axis, and a first step surface is arranged between the first inclined planes of the adjacent two sections;
and/or, the second sidewall has a second inclined plane of several segments distributed along the first axis, and a second step surface is arranged between the second inclined planes of two adjacent segments.

Preferably, as an implementable method, the first synchronous structure and the second synchronous structure are both circular structures, and the centers coincide with the first axis; the convex part and the groove include multiple parts, and the convex part corresponds to the groove part one by one, the multiple convex parts and the multiple grooves are respectively set at intervals along the circumferential around the first axis.

Preferably, as an implementable method, the first rotation part, the friction plate, the third rotation part, the second synchronous structure and the first synchronous structure are arranged in sequence along the first axis, the pressure regulating component also includes a synchronous shaft coaxially set with the first axis, the synchronous shaft is set in the through hole at the rotation center of the friction plate, the third rotation part and the second synchronous structure, and the two ends of the synchronous shaft are fixedly connected with the first synchronous structure and the first rotation part respectively; the first inclined plane is inclined from the root of the convex part to the top in the direction of approaching each other, and the second inclined plane is inclined from the bottom of the groove to the top in the direction of far away from each other.

Preferably, as an implementable method, the pressure regulating component also includes a preload nut, the synchronous shaft has a thread, and the preload nut is matched with the synchronous shaft thread; the preload nut can be fixed to the first synchronous structure and can be fixed to the synchronous shaft.

Preferably, as an implementable method, the rotational energy dissipation unit is divided into two groups, they are the first rotation energy dissipation unit and the second rotation energy dissipation unit; the second rotation part in the first rotation energy dissipation unit rotates with the fourth rotation part in the second rotation energy dissipation unit around the second axis, the fourth rotation part in the first rotation energy dissipation unit rotates with the second rotation part in the second rotation energy dissipation unit around the third axis, the two first rotation arms and the two second rotation arms form a parallelogram structure.

Preferably, as an implementable method, the variable parameter friction damper also includes a first connector and a second connector, the second rotation part in the first rotation energy dissipation unit and the fourth rotation part in the second rotation energy dissipation unit are both rotationally matched with the first connector around the second axis, the fourth rotation part in the first rotation energy dissipation unit and the second rotation part in the second rotation energy dissipation unit are both rotationally matched with the second connector around the third axis, and the first connector and the second connector are respectively used to install to the building matrix.

Preferably, as an implementable method, the materials of the first connector, the second connector, the first rotation arm, the second rotation arm and the pressure regulating component are all metal;
and/or, the material of the friction plate is resin matrix composite material or metal.

Compared with the existing technology, the beneficial effect of the invention lies in:
when the building matrix deforms due to seismic energy, the second rotation part on the first rotation arm and the fourth rotation part on the second rotation arm will move relatively under the action of the deformation force of the building matrix, resulting in the relative rotation of the first rotation arm and the second rotation arm around the first axis, because the friction plate is squeezed between the first rotation part of the first rotation arm and the third rotation part of the second rotation arm, when the first rotation arm and the second rotation arm rotate relatively, the two sides of the friction plate will produce a certain friction with the first rotation part and the third rotation part respectively, the friction work can dissipate energy and provide a certain bearing capacity. The pressure regulating component can adjust the distance between the first rotation part and the third rotation part, with the change of the distance between the first rotation part and the third rotation part, the pressure on both sides of the friction plate will also change, accordingly, when the first rotation arm and the second rotation arm rotate relatively, the friction generated between the first rotation part and the third rotation part and the two sides of the friction plate will also change, so as to realize the regulation of bearing capacity and energy dissipation performance.

Therefore, the variable parameter friction damper provided by the invention can adjust the bearing capacity and energy dissipation performance according to the level of external excitation encountered by the building matrix in the case of different types and levels of disasters and different deformation levels, and the variable parameter friction damper of this invention has strong adaptability.

### BRIEF DESCRIPTION OF THE DRAWINGS

In order to more clearly explain the technical scheme in the embodiments or the existing technology of the invention, the following will briefly introduce the drawings needed to be used in the embodiments or existing technology description. Obviously, the drawings in the following description are only the embodiments of the invention, for ordinary technicians in this field, other drawings can be obtained according to the provided drawings without paying creative labor.

FIG. 1 is the three-dimensional structure diagram of the variable parameter friction damper provided by the embodiment of the invention;

FIG. 2 is the explosion structure diagram of the variable parameter friction damper provided by the embodiment of the invention;

FIG. 3 is the top-view structure diagram of the variable parameter friction damper provided by the embodiment of the invention;

FIG. 4 is the three-dimensional structure diagram of another perspective of the variable parameter friction damper provided by the embodiment of the invention;

FIG. 5 is the side view structure diagram of the rotation energy dissipation unit provided by the embodiment of the invention;

FIG. 6 is the first explosion diagram of the partial structure of the pressure regulating component provided by the embodiment of the invention;

FIG. 7 is the first assembly diagram of the partial structure of the pressure regulating component provided by the embodiment of the invention;

FIG. 8 is the up-looking structure diagram of the first synchronous structure of the pressure regulating component provided by the embodiment of the invention;

FIG. 9 is the top view structure diagram of the second synchronous structure of the pressure regulating component provided by the embodiment of the invention;

FIG. 10 is the bearing capacity-deformation relationship diagram of the variable parameter friction damper provided by the embodiment of the invention when using the structure shown in FIG. 7-FIG. 9;

FIG. 11 is the second explosion diagram of the partial structure of the pressure regulating component provided by the embodiment of the invention;

FIG. 12 is the second assembly diagram of the partial structure of the pressure regulating component provided by the embodiment of the invention;

FIG. 13 is the top view structure diagram of the second synchronous structure of the pressure regulating component provided by the embodiment of the invention;

FIG. 14 is the bearing capacity-deformation relationship diagram of the variable parameter friction damper provided by the embodiment of the invention when using the structure shown in FIG. 11-FIG. 13;

### THE DESCRIPTION OF THE DRAWING MARKS

110—first rotation arm; 120—second rotation arm; 130—friction plate; 140—first synchronous structure; 141—convex part; 142—first inclined plane; 150—second synchronous structure; 151—groove; 152—second inclined plane; 153—second step surface; 154—second lower inclined plane; 155—second upper inclined plane; 160—synchronous shaft; 170—preload nut; 180—first rotation energy dissipation unit; 190—second rotation energy dissipation unit; 200—first connector; 210—first axis pin; 300—second connector; 310—second axis pin.

### DETAILED DESCRIPTION OF THE EMBODIMENTS

The following will be a clear and complete description of the technical scheme of the invention in combination with the accompanying drawings. Obviously, the described embodiments are part of the embodiments of the invention, not all of the embodiments. Based on the embodiments of the invention, all other embodiments obtained by ordinary technicians in this field without making creative labor belong to the protection scope of the invention.

The following is a further detailed description of the invention through specific embodiments and illustrations.

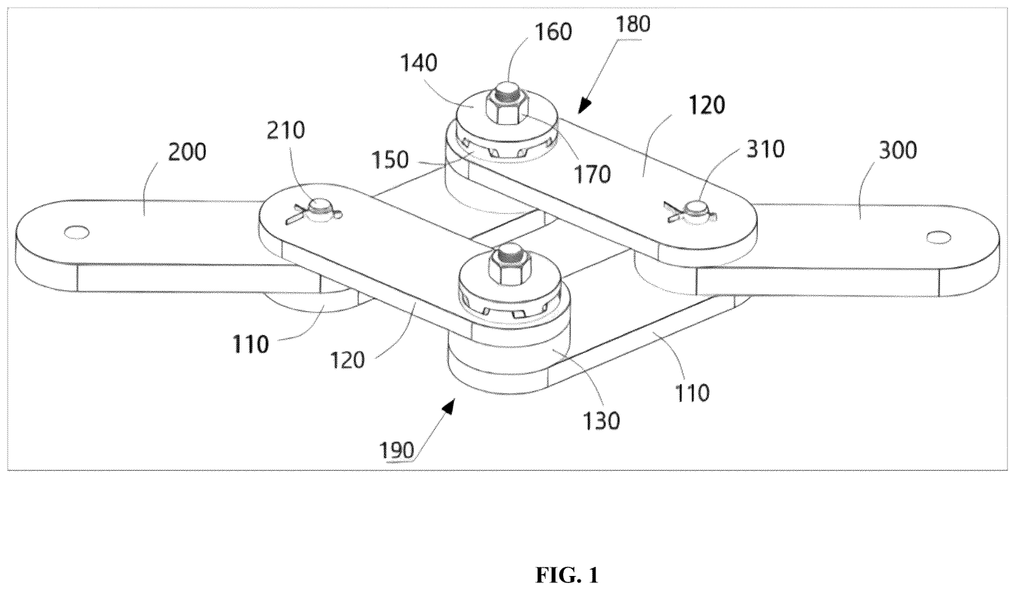

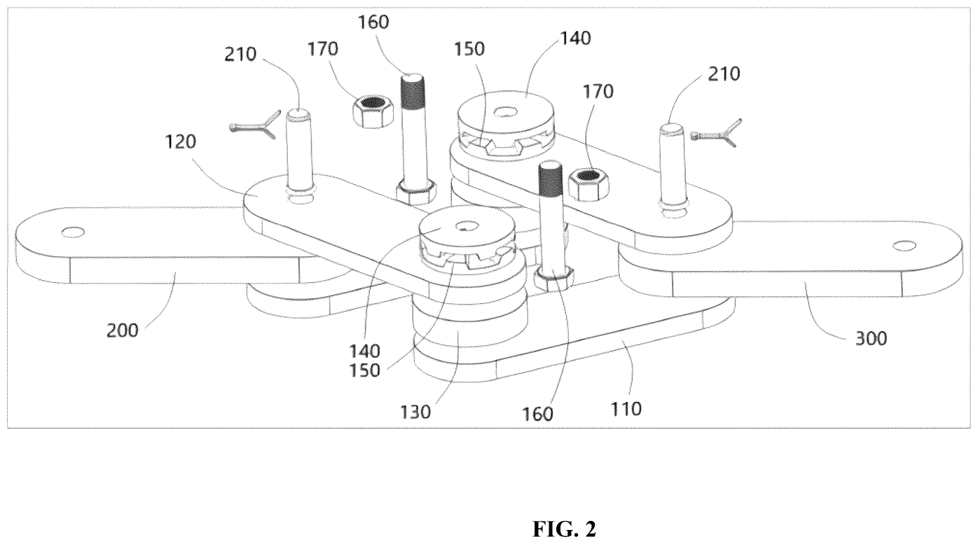

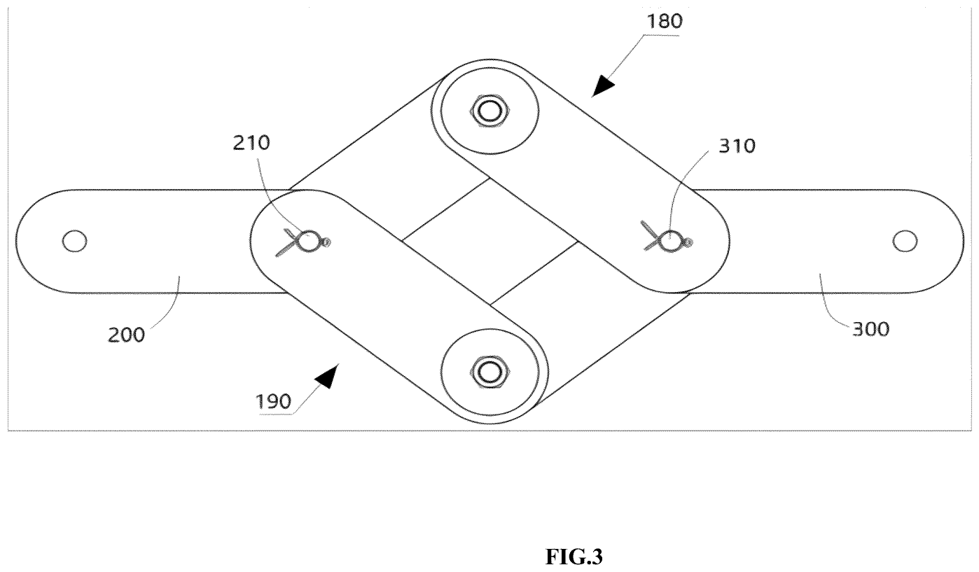

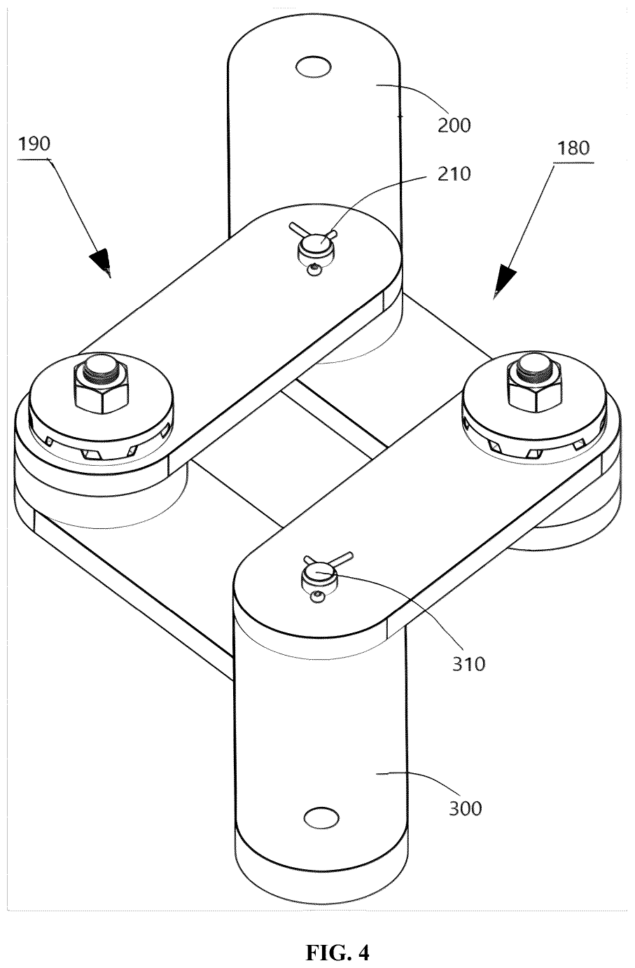

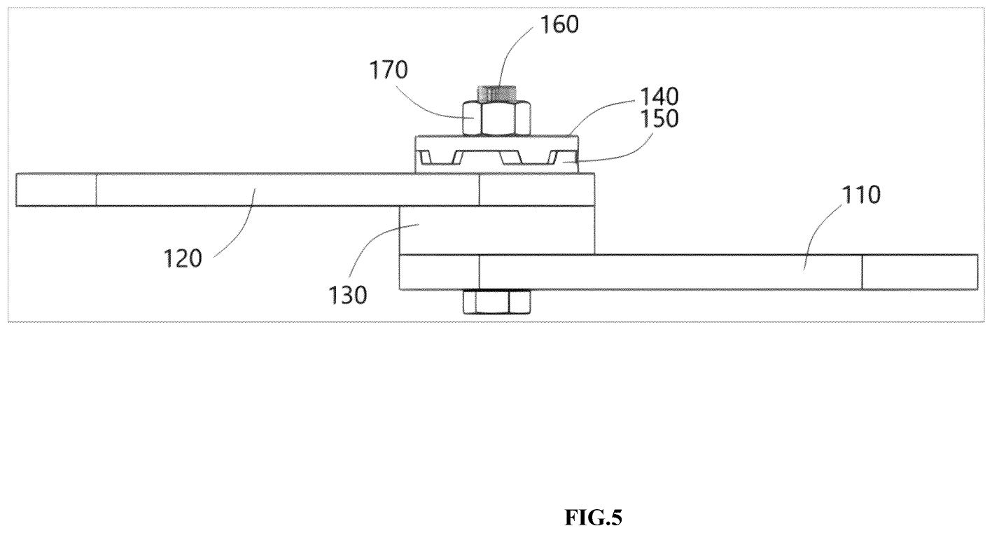

Refer to FIG. 1-FIG. 5, this embodiment provides a variable parameter friction damper, which includes a rotation energy dissipation unit, the rotation energy dissipation unit includes the first rotation arm 110, the second rotation arm 120, the friction plate 130 and the pressure regulating component; the first rotation arm 110 has the first rotation part and the second rotation part, and the second rotation arm 120 has the third rotation part and the fourth rotation part, the first rotation part and the third rotation part rotate around the first axis, and the friction plate 130 is squeezed between the first rotation part and the third rotation part, the pressure regulating component is used to adjust the distance between the first rotation part and the third rotation part, the second rotation part and the fourth rotation part are respectively hinged on the building matrix.

When the building matrix deforms due to seismic energy, the second rotation part on the first rotation arm 110 and the fourth rotation part on the second rotation arm 120 will move relatively under the action of the deformation force of the building matrix, resulting in the relative rotation of the first rotation arm 110 and the second rotation arm 120 around the first axis, because the friction plate 130 is squeezed between the first rotation part of the first rotation arm 110 and the third rotation part of the second rotation arm 120, when the first rotation arm 110 and the second rotation arm 120 rotate relatively, the sides of the friction plate 130 will produce certain friction with the first rotation part and the third rotation part respectively, the friction work can dissipate energy and provide a certain bearing capacity. The pressure regulating component can adjust the distance between the first rotation part and the third rotation part, with the change of the distance between the first rotation part and the third rotation part, the pressure on both sides of the friction plate 130 will also change, accordingly, when the first rotation arm 110 and the second rotation arm 120 rotate relatively, the friction force generated between the the first rotation part and the third rotation part and the two sides of the friction plate 130 will also change, so as to realize the regulation of bearing capacity and energy dissipation performance.

Therefore, the variable parameter friction damper provided by the invention can adjust the bearing capacity and energy dissipation performance according to the level of external excitation encountered by the building matrix in the case of different types and levels of disasters and different deformation levels, and the variable parameter friction damper of this invention has strong adaptability.

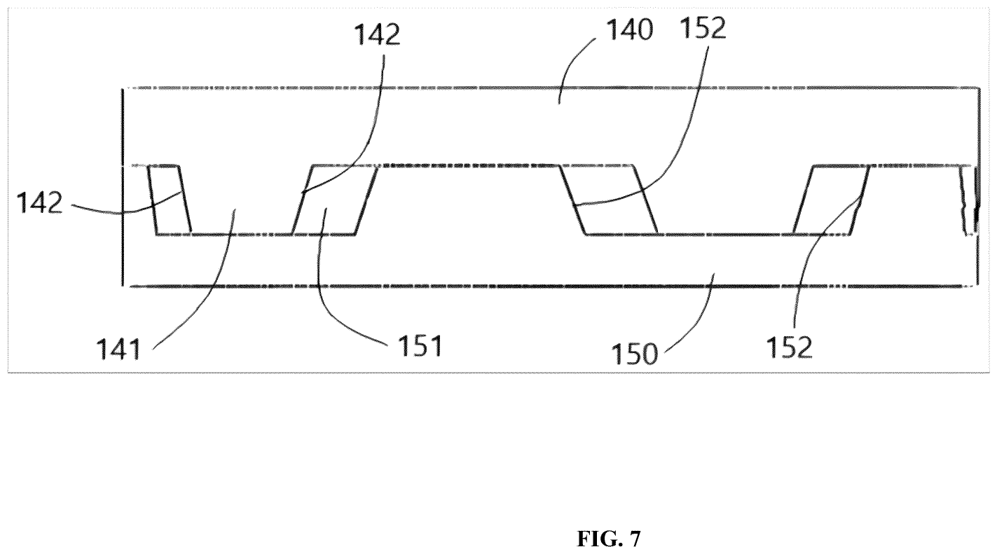

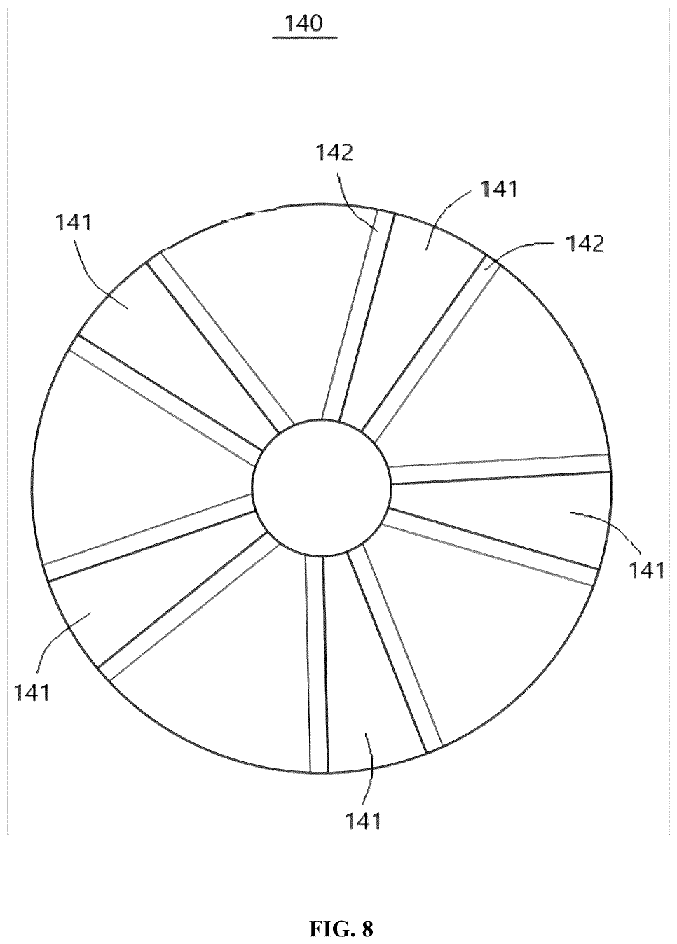

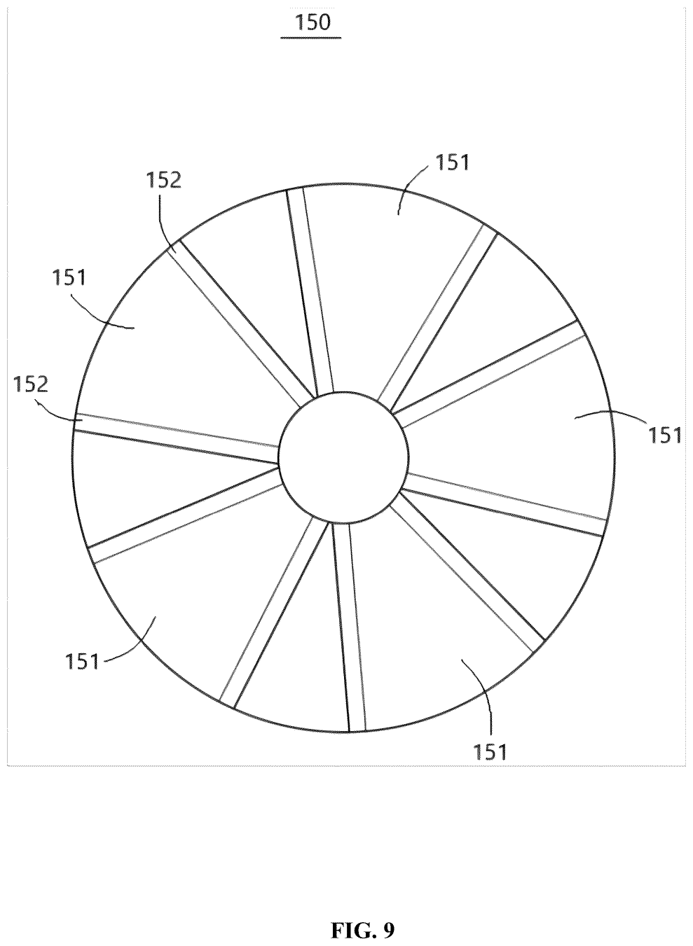

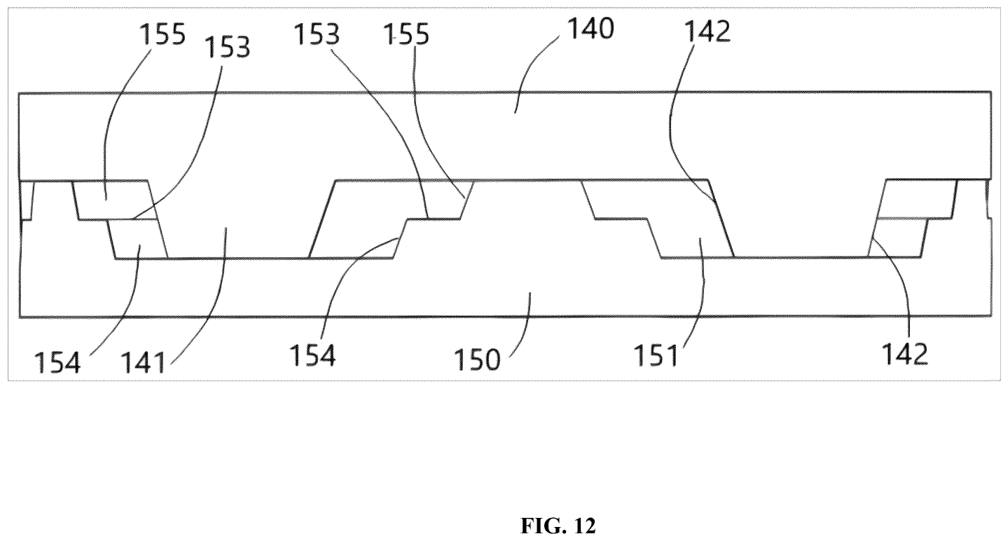

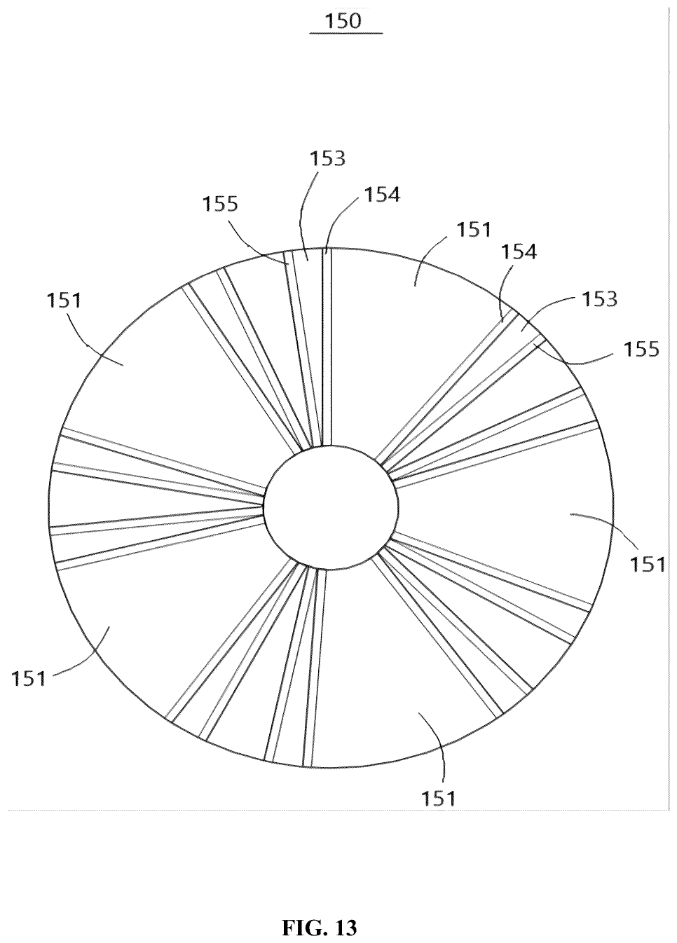

Refer to FIG. 1-FIG. 14, the first synchronous structure 140 and the second synchronous structure 150 can be set in the specific structure of the above pressure regulating component, the first synchronous structure 140 is fixedly connected with the first rotation part of the first rotating arm 110 or the two are set as an integrated forming structure, so that the first synchronous structure 140 can rotate synchronously with the first rotation part; the second synchronous structure 150 is fixedly connected with the third rotation part of the second rotation arm 120 or the two are set as an integrated forming structure, so that the second synchronous structure 150 can rotate synchronously with the third rotation part. The first synchronous structure 140 and the second synchronous structure 150 are set relatively to each other along the first axis, the first inclined plane 142 is set on the first synchronous structure 140, and the second inclined plane 152 is set on the second synchronous structure 150, so that the first inclined plane 142 and the second inclined plane 152 are set at an angle with the first axis, and the first inclined plane 142 and the second inclined plane 152 are set relatively to each other along the circumferential direction, when the building matrix is subjected to an earthquake and the first rotation arm 110 and the second rotation arm 120 are rotated relatively to each other, the first synchronous structure 140 and the second synchronous structure 150 will also rotate relatively to each other, if the vibration level is low, the relative rotation angle between the first synchronous structure 140 and the second synchronous structure 150 is small, the first inclined plane 142 on the first synchronous structure 140 will not contact with the second inclined plane 152 on the second synchronous structure 150, the sliding friction between the friction plate 130 and the first rotation part and the third rotating part plays an energy dissipation role, which can meet the needs of the building matrix for low energy consumption and bearing capacity. If the vibration level is higher, the relative rotation angle between the first synchronous structure 140 and the second synchronous structure 150 will be larger, so that the first inclined plane 142 on the first synchronous structure 140 and the second inclined plane 152 on the second synchronous structure 150 will contact and fit each other, at this time, the first synchronous structure 140 will provide the load component in the first axis direction to the third rotation part of the second rotation arm 120 through the second synchronous structure 150, and the second synchronous structure 150 will provide the load component in the first axis direction to the first rotation part of the first rotation arm 110 through the first synchronous structure 140, by increasing the extrusion force on the friction plate 130, the energy dissipation effect of the damper can be enhanced, and the bearing capacity can be increased to meet the demand of the building matrix for high energy consumption and bearing capacity. Therefore, the adaptive adjustment of the damper parameters under different vibration levels can be realized to meet the energy dissipation-seismic reduction performance requirements of the building matrix in different stress stages. In addition, the use of the above structure is conducive to reducing the volume of the damper and the occupied space, the force transmission is clear, and the mechanical properties are easy to grasp.

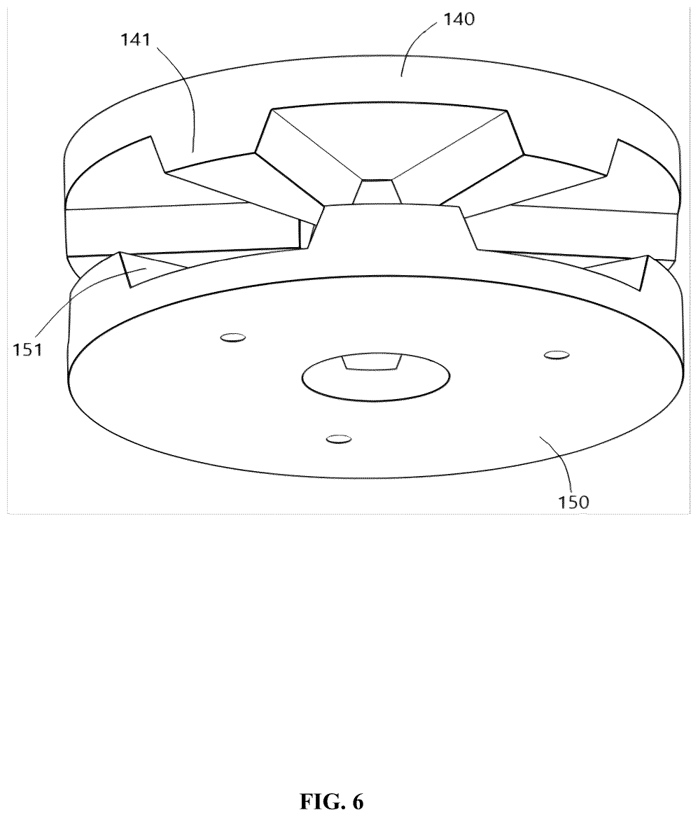

Specifically, refer to FIG. 6-FIG. 14, the convex part 141 facing the second synchronous structure 150 can be set on the first synchronous structure 140, and the groove 151 can be set on the second synchronous structure 150, the convex part 141 on the first synchronous structure 140 is matched with the groove 151 on the second synchronous structure 150, the first inclined plane 142 is set on the two first side walls opposite to the convex part 141, and the second inclined plane 152 is set on the radial groove walls on both sides of the groove 151, so that no matter which direction the first synchronous structure 140 and the second synchronous structure 150 rotate in, the first inclined plane 142 and the second inclined plane 152 can play a role in enhancing the energy dissipation performance and bearing capacity when the vibration level reaches a certain height, which is more practical.

Preferably, one or more of the following three schemes can be used to further enhance the adaptability of the damper:

The first scheme, a gap is set between the first side wall of the convex part 141 and the second side wall of the groove 151, so that the damper can adapt to a variety of vibration levels and has stronger adaptability.

The second scheme, several segments of the first inclined plane 142 distributed along the first axis are set on the first side wall of the convex part 141, and the first step surface is set between the first inclined plane 142 of the adjacent two segments, so that the damper can adapt to a variety of vibration levels and it is more adaptable.

The third scheme, as shown in FIG. 6-FIG. 14, several second inclined planes 152 distributed along the first axis are set on the second side wall of groove 151, and the second step surface 153 is set between the two adjacent second inclined planes 152, so that it can adapt to a variety of vibration levels and has stronger adaptability.

Refer to FIG. 6-FIG. 10, when there is a gap between the first side wall and the second side wall, and the second inclined plane 153 is a segment, the specific working mechanism is as follows:

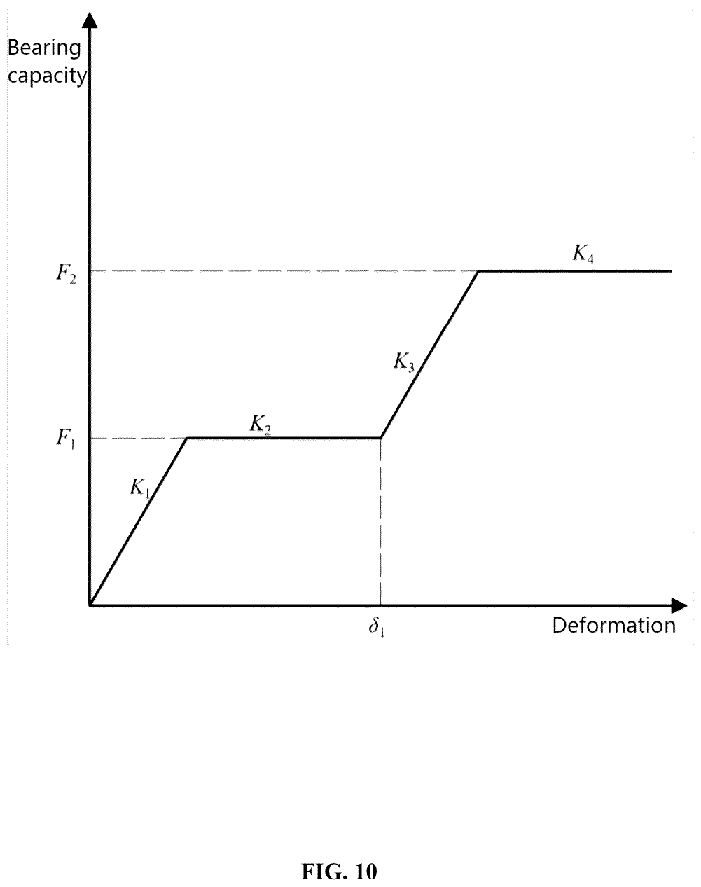

Under the action of small earthquake or wind load: the interlaminar deformation of the structure is small, the relative sliding angle between the first synchronous structure 140 and the second synchronous structure 150 in the pressure regulating component is less than δ1, the first inclined plane 142 is not in contact with the second inclined plane 152, and the pressure regulating component does not play a role, the energy dissipation effect of the damper is only provided by the sliding friction between the friction plate 130, the first rotation arm 110 and the second rotating arm 120, at this time, the relationship between bearing capacity and deformation is shown in stages K1 and K2 in FIG. 10, and the maximum bearing capacity is F1.

Under the action of medium earthquake: the interlaminar deformation of the structure is slightly larger than that under the small earthquake, but the relative sliding angle between the first synchronous structure 140 and the second synchronous structure 150 in the pressure regulating component is still less than δ1, the first inclined plane 142 and the second inclined plane 152 are still not in contact, and the pressure regulating component has not yet played a role, the energy dissipation effect of the damper is still only provided by the sliding friction between the friction plate 130, the first rotating arm 110 and the second rotating arm 120, at this time, the maximum bearing capacity is still F1, the relationship between bearing capacity and deformation is shown in stages K1 and K2 in FIG. 10.

Under the action of large earthquake: the interlayer deformation of the structure is significantly increased compared with that under the medium earthquake, the relative sliding angle between the first synchronous structure 140 and the second synchronous structure 150 in the pressure regulating component is greater than δ1, the first inclined plane 142 and the second inclined plane 152 contact and squeeze each other, the pressure regulating component plays a role, and additional extrusion pressure can be applied to the friction plate 130 to enhance the energy dissipation effect of the damper, at this time, the relationship between bearing capacity and deformation is shown in the K3 and K4 stages in FIG. 10, and the maximum bearing capacity is F2.

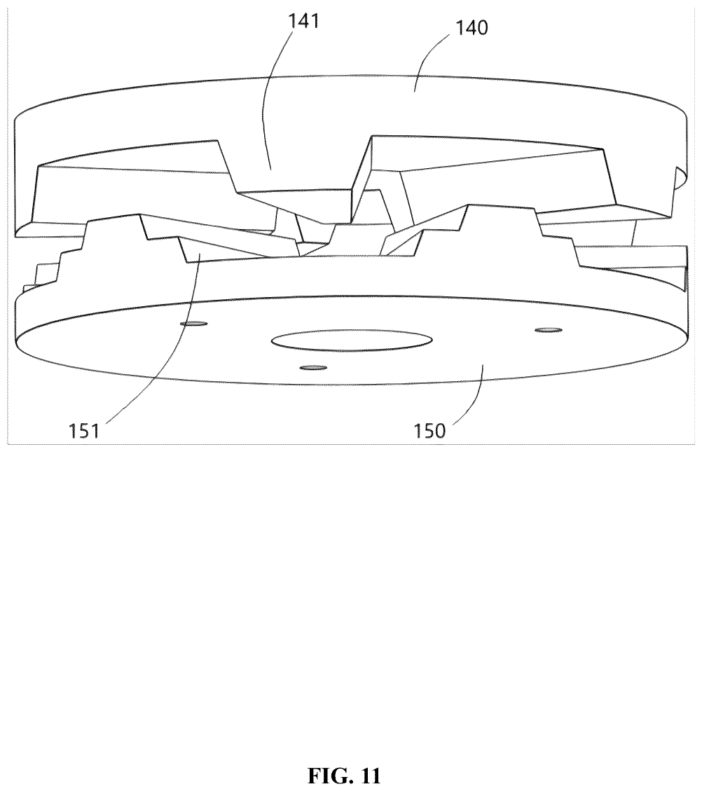

Refer to FIG. 11-FIG. 14, when there is a gap between the first side wall and the second side wall, and the second inclined plane 152 is two segments and the second step plane 153 is one, the second inclined plane 152 near the bottom of the groove is defined as the second lower inclined plane 154, and the second inclined plane 152 is defined as the second upper inclined plane 155, the specific working mechanism is as follows:

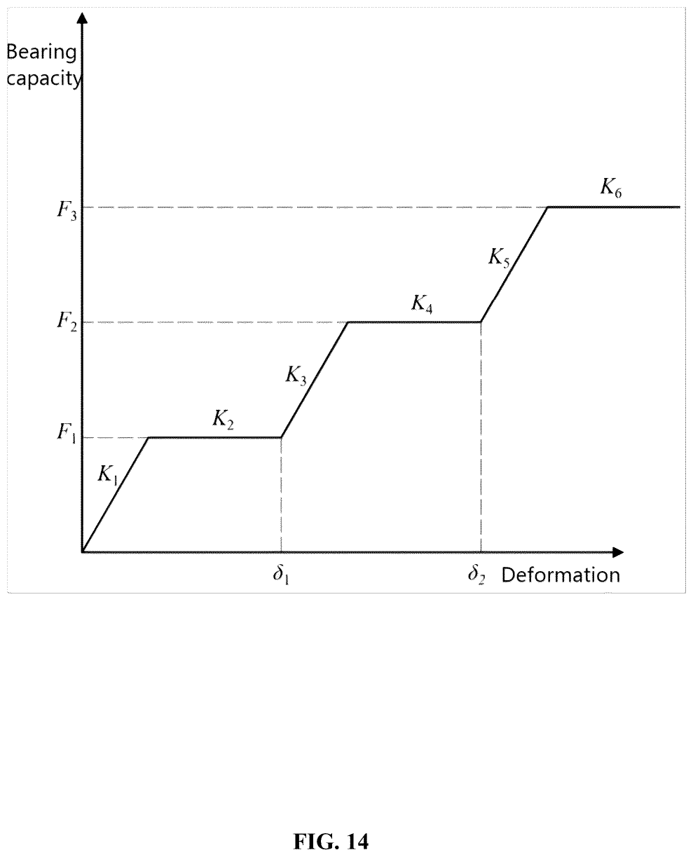

Under the action of small earthquake or wind load: the interlaminar deformation of the structure is small, the relative sliding angle between the first synchronous structure 140 and the second synchronous structure 150 in the pressure regulating component is less than δ1, the first inclined plane 142 is not in contact with the second inclined plane 152, and the pressure regulating component does not play a role, the energy dissipation effect of the damper is only provided by the sliding friction between the friction plate 130, the first rotation arm 110 and the second rotating arm 120, at this time, the relationship between bearing capacity and deformation is shown in stages K1 and K2 in FIG. 14, and the maximum bearing capacity is F1.

Under the action of medium earthquake: the interlaminar deformation of the structure is slightly larger than that under the small earthquake, but the relative sliding angle between the first synchronous structure 140 and the second synchronous structure 150 in the pressure regulating component is still less than δ1, the first inclined plane 142 and the second inclined plane 152 are still not in contact, and the pressure regulating component has not yet played a role, the energy dissipation effect of the damper is still only provided by the sliding friction between the friction plate 130 and the first rotating arm 110 and the second rotating arm 120, at this time, the relationship between bearing capacity and deformation is shown in stages K1 and K2 in FIG. 14, and the maximum bearing capacity is still F1.

Under the action of large earthquake: the interlaminar deformation of the structure is significantly larger than that under medium earthquake, the relative sliding angle of the first synchronous structure 140 and the second synchronous structure 150 in the pressure adjustment component is greater than δ1 and less than δ2, the first inclined plane 142 of the first synchronous structure 140 and the second lower inclined plane 154 of the second synchronous structure 150 contact and squeeze each other, the pressure regulating component plays a role, and additional extrusion pressure can be applied to the friction plate 130 to enhance the energy dissipation of the damper, at this time, the relationship between bearing capacity and deformation is shown in K3 and K4 stages in FIG. 14, and the maximum bearing capacity is F2.

Under the action of super large earthquake, the interlaminar deformation of the structure is further increased compared with that under large earthquake, the relative sliding angle between the first synchronous structure 140 and the second synchronous structure 150 in the pressure regulating component is greater than δ2, the first synchronous structure 140 moves along the rotation axis in the direction of deviating from the second synchronous structure 150 and crosses the second step surface 153, the first inclined plane 142 on the first synchronous structure 140 contacts and squeezes each other with the second upper inclined plane 155 of the second synchronous structure 150, and the pressure regulating component plays a role again, the second upper inclined plane 155 of the second synchronous structure 150 will again apply additional extrusion pressure to the friction plate 130 to enhance the energy dissipation effect of the damper, at this time, the relationship between bearing capacity and deformation is shown in the K5 and K6 stages in FIG. 14, and the maximum bearing capacity is F3.

The first synchronous structure 140 and the second synchronous structure 150 can be set as a circular ring structure, and its center is set to coincide with the first axis, on this basis, the convex part 141 and the groove 151 are set to multiple, and the multiple convex parts 141 are set on the first synchronous structure 140 at interval along the circumferential direction around the first axis, and the multiple grooves 151 are set on the second synchronous structure 150 at the circumferential interval around the first axis, in this way, the force balance of the damper can be improved. It is preferred to arrange multiple convex parts 141 and multiple grooves 151 evenly along the circumferential direction around the first axis, and the force balance is better.

Specifically, the first rotation part, the friction plate 130, the third rotation part, the second synchronous structure 150 and the first synchronous structure 140 are arranged in sequence along the first axis. In the specific structure of the pressure regulating component, the synchronous shaft 160 is set coaxially with the first axis. The synchronous shaft 160 is set in the through hole at the rotation center of the friction plate 130, the third rotation part and the second synchronous structure 150, and the two ends of the synchronous shaft 160 are fixedly connected with the the first synchronous structure 140, ad the first rotation part of the first rotation arm 110 respectively. In this way, the third rotation part and the second synchronous structure 150 can rotate around the synchronous shaft 160, which realizes the rotation coordination between the third rotation part and the first rotation part, as well as the rotation coordination between the first synchronous structure 140 and the second synchronous structure 150, and the synchronous shaft 160 can also locate the friction plate 130. On this basis, the first inclined plane 142 of the convex part 141 is set to tilt from the root of the convex part 141 to the top in the direction close to each other, and the second inclined plane 152 of the groove 151 is set to tilt from the bottom of the groove 151 to the top in the direction far from each other. In this way, when the higher vibration level leads to a larger relative sliding angle between the first rotation part of the first rotation arm 110 and the third rotation part of the second rotation arm 120, under the action of the relative sliding between the first inclined plane 142 and the second inclined plane 152, the first synchronous structure 140 and the second synchronous structure 150 can move smoothly in a direction far from each other, in order to realize the enhancement effect of energy dissipation performance and bearing capacity, and adapt to the demand of building matrix for high energy consumption and bearing capacity. Optionally, the third rotation part of the second rotation arm 120 is welded together with the second synchronous structure 150 or fixed together by bolts.

The preload nut 170 can also be set in the specific structure of the pressure regulating component, and the thread can be set on the synchronous shaft 160, the preload nut 170 can be matched with the synchronous shaft 160 thread. During assembly, the preload nut 170 can be screwed from the end of the synchronous shaft 160 away from the first rotating arm 110 to the synchronous shaft 160, and the preload nut 170 can be fastened to the preset preload force. In this way, the initial bearing capacity and energy dissipation performance of the damper can be flexibly adjusted by adjusting the initial preload force of the preload nut 170. After the preload locking of the preload nut 170 is completed, the preload nut 170 can be fixedly connected with the first synchronous structure 140 (preferably welded), and the preload nut 170 can also be fixedly connected with the synchronous shaft 160 (preferably welded), so as to realize the indirect fixation of the synchronous shaft 160 and the first synchronous structure 140, so that the first synchronous structure 140 can rotate synchronously with the first rotation part of the first rotation arm 110 under the drive of the synchronous shaft 160.

Specifically, the fine-tooth high-strength bolt can be used as the above-mentioned synchronous shaft 160, which can ensure the connection strength between the synchronous shaft 160 and the preload nut 170. When assembling under this condition, the high-strength bolt of fine teeth can be first passed through the through hole at the rotation center of the first rotation part, the friction plate 130, the third rotation part, the second synchronous structure 150 and the first synchronous structure 140 in turn. And then the preload nut 170 is tightened to the fine-tooth high-strength bolt, the combined structure of the first rotation part, the friction plate 130, the third rotation part, the second synchronous structure 150 and the first synchronous structure 140 is pressed from both sides by using the nut of the fine-tooth high-strength bolt and the preload nut 170, and the nut of the fine-tooth high-strength bolt is fixedly connected with the first rotation part (preferably welded).

Preferably, the above rotation energy dissipation units can be set as two groups, the two groups of rotation energy dissipation units are defined as the first rotation energy dissipation unit 180 and the second rotation energy dissipation unit 190 respectively, the second rotation part of the first rotation arm 110 in the first rotation energy dissipation unit 180 and the fourth rotation part of the second rotation arm 120 in the second rotation energy dissipation unit 190 rotate around the second axis, and the fourth rotation part of the second rotation arm 120 in the first rotation energy dissipation unit 180 rotates with the second rotation part of the first rotation arm 110 in the second rotation energy dissipation unit 190, so that the two first rotation arms 110 and the two second rotation arms 120 are enclosed into a parallelogram structure. In this way, when the building matrix deforms due to the earthquake, the two sets of rotation energy dissipation units 100 can work together to enhance the energy dissipation effect.

In the variable parameter friction damper provided in this embodiment, the first connector 200 and the second connector 300 can also be set, the second rotation part of the first rotation arm 110 in the first rotation energy dissipation unit 180 and the fourth rotation part of the second rotation arm 120 in the second rotation energy dissipation unit 190 are both rotationally matched with the first connector 200 around the second axis, and the fourth rotation part of the second rotation arm 120 in the first rotation energy dissipation unit 180 and the second rotation part of the first rotation arm 110 in the second rotation energy dissipation unit 190 are rotationally matched with the second connector 200 around the third axis, at the same time, the first connector 200 and the second connector 300 are installed on the building substrate respectively, so that the second rotation part of the first rotation arm 110 and the fourth rotation part of the second rotation arm 120 can be indirectly connected with the building substrate. Moreover, the setting of the first connector 200 and the second connector 300 can increase the interaction area between the damper and the building matrix, improve the energy dissipation performance of the damper, and improve the connection reliability between the damper and the building matrix. Specifically, the second rotation part of the first rotation arm 110 in the first rotation energy dissipation unit 180 and the fourth rotation part of the second rotation arm 120 in the second rotation energy dissipation unit 190 can be hinged with the first connector 200 through the first axis pin 210, the fourth rotation part of the second rotation arm 120 in the first rotation energy dissipation unit 180 and the second rotation part of the first rotation arm 110 in the second rotation energy dissipation unit 190 are hinged with the second connector 300 through the second axis pin 310, where the central axis of the first axis pin 210 coincides with the second axis pin, the central axis of the second axis pin 310 coincides with the third axis pin.

Specifically, the materials of the first connector 200, the second connector 300, the first rotation arm 110, the second rotation arm 120 and the pressure regulating component can be set to metal (preferably steel), in this way, the structural strength of the damper can be improved, and the welding requirements between some structures can be facilitated.

The material of the friction plate 130 can be set as resin matrix composite material, metal or other high-performance friction material to ensure the energy consumption effect of the friction plate 130.

In the description of the invention, it should be noted that unless otherwise clearly defined and limited, the terms ‘installation’ and ‘connection’ should be understood in a broad sense. For example, it can be a fixed connection, a detachable connection, or an integrated connection. It can be mechanical connection or electrical connection; it can be directly connected or indirectly connected through an intermediate medium, which can be the internal connection of two components. For ordinary technicians in this field, the specific meaning of the above terms in this invention can be understood in detail.

Finally, it should be stated that the above embodiments are only used to illustrate the technical scheme of the invention, not to restrict it; although the invention is described in detail with reference to the aforementioned embodiments, the general technical personnel in this field should understand that they can still modify the technical scheme recorded in the aforementioned embodiments, or replace some or all of the technical features with equivalents; these modifications or replacements do not make the essence of the corresponding technical scheme out of the scope of the technical scheme of each embodiment of the invention.

What is claimed is:

1. A variable parameter friction damper, including a rotation energy dissipation unit, which includes a first rotation arm, a second rotation arm, a friction plate and a pressure regulating component; the first rotation arm has a first rotation part and a second rotation part, and the second rotation arm has a third rotation part and a fourth rotation part, the first rotation part and the third rotation part rotate around the first axis, and the friction plate is squeezed between the first rotation part and the third rotation part, the pressure regulating component is used to adjust the distance between the first rotation part and the third rotation part, and the second rotation part and the fourth rotation part are respectively hinged on the building matrix.

2. The variable parameter friction damper according to claim 1, the pressure regulating component includes the first synchronous structure and the second synchronous structure, the first synchronous structure is fixed or integrated with the first rotation part, and the second synchronous structure is fixed or integrated with the third rotation part; the first synchronous structure and the second synchronous structure are set relatively along the first axis, the first synchronous structure has the first inclined plane, and the second synchronous structure has the second inclined plane, the first inclined plane and the second inclined plane form an angle with the first axis and are set relatively to each other along the circumferential direction.

3. The variable parameter friction damper according to claim 2, the first synchronous structure is provided with a convex part toward the second synchronous structure, the second synchronous structure is provided with a groove, the convex part is matched with the groove, the two first side walls opposite to the convex part have the first inclined plane, and the two second side walls opposite to the groove have the second inclined plane.

4. The variable parameter friction damper according to claim 3, there is a gap between the first sidewall and the second sidewall; and/or, the first side wall has a number of segments of the first inclined plane distributed along the first axis, and a first step surface is arranged between the first inclined planes of the adjacent two segments; and/or, the second sidewall has a second inclined plane of several segments distributed along the first axis, and a second step surface is arranged between the second inclined planes of two adjacent segments.

5. The variable parameter friction damper according to claim 3, the first synchronous structure and the second synchronous structure are both circular structures, and the centers coincide with the first axis; the convex part and the groove include multiple parts, and the convex part corresponds to the groove part one by one, the multiple convex parts and the multiple grooves are respectively set at interval along the circumferential around the first axis.

6. The variable parameter friction damper according to claim 3, the first rotation part, the friction plate, the third rotation part, the second synchronous structure and the first synchronous structure are arranged in sequence along the first axis, the pressure regulating component also includes a synchronous shaft coaxially set with the first axis, the synchronous shaft is set in the through hole at the rotation center of the friction plate, the third rotation part and the second synchronous structure, and the two ends of the synchronous shaft are fixedly connected with the first synchronous structure and the first rotation part respectively; the first inclined plane is inclined from the root of the convex part to the top in the direction of approaching each other, and the second inclined plane is inclined from the bottom of the groove to the top in the direction of far away from each other.

7. The variable parameter friction damper according to claim 6, the pressure regulating component also includes a preload nut, the synchronous shaft has a thread, and the preload nut is matched with the synchronous shaft thread; the preload nut can be fixed to the first synchronous structure and can be fixed to the synchronous shaft.

8. The variable parameter friction damper according to claim 1, the rotation energy dissipation unit is divided into two groups, they are the first rotation energy dissipation unit and the second rotation energy dissipation unit; the second rotation part in the first rotation energy dissipation unit rotates with the fourth rotation part in the second rotation energy dissipation unit around the second axis, the fourth rotation part in the first rotation energy dissipation unit rotates with the second rotation part in the second rotation energy dissipation unit around the third axis, the two first rotation arms and the two second rotation arms form a parallelogram structure.

9. The variable parameter friction damper according to claim 8, the variable parameter friction damper also includes a first connector and a second connector, the second rotation part in the first rotation energy dissipation unit and the fourth rotation part in the second rotation energy dissipation unit are both rotationally matched with the first connector around the second axis, the fourth rotation part in the first rotation energy dissipation unit and the second rotation part in the second rotation energy dissipation unit are both rotationally matched with the second connector around the third axis, the first connector and the second connector are respectively used to install to the building matrix.

10. The variable parameter friction damper according to claim 9, the materials of the first connector, the second connector, the first rotation arm, the second rotation arm and the pressure regulating component are all metal; and/or, the material of the friction plate is resin matrix composite material or metal.
